(19) United States
(12) Patent Application Publication
(10) Pub. No.: US 2025/0031674 A1
(43) Pub. Date: Jan. 30, 2025

(54) Hummingbird Feeder Device

(71) Applicant: Dart Clark, Show Low, AZ (US)

(72) Inventor: Dart Clark, Show Low, AZ (US)

(21) Appl. No.: 18/773,743

(22) Filed: Jul. 16, 2024

Related U.S. Application Data
(60) Provisional application No. 63/516,088, filed on Jul. 27, 2023.

(51) Int. Cl. A01K 39/02

(52) U.S. Cl. CPC A01K 39/0206

(57) ABSTRACT

A hummingbird feeder device is disclosed that is an easier and more convenient way to feed and attract hummingbirds. The hummingbird feeder device comprises a housing component that is configured in a triangular-shaped elongated design with an open interior cavity. An internal bladder or pouch filled with nectar/hummingbird food is disclosed within the open interior cavity. The housing component comprises multiple removable sections on the triangular design, which are removed to access the pouch. Once removed, feeding plugs are pulled out from the pouch on all sides of the triangular design. The feeding plugs typically resemble a live flower with a hole in the center for access to the nectar from the pouch. When the feeding plugs are pulled out, nectar from the pouch is exposed, which will in turn attract and feed nearby hummingbirds.

### CROSS-REFERENCE TO RELATED APPLICATION

The present application claims priority to, and the benefit of, U.S. Provisional Application No. 63/516,088, which was filed on Jul. 27, 2023, and is incorporated herein by reference in its entirety.

### FIELD OF THE INVENTION

The present invention relates generally to the field of hummingbird feeder devices. More specifically, the present invention relates to a housing with an internal pouch filled with a food mixture for hummingbirds. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in hummingbird feeder devices. Generally, attracting and feeding hummingbirds doesn't have to be a time-consuming process. However, the current method requires individuals to purchase a feeder, then mix food, fill the feeder, and then refill it when empty by repeating the process. Existing feeders do not tend to be easily portable or easy to dispose of.

Furthermore, people who are fortunate enough to live in an area inhabited by hummingbirds often encourage their presence by the use of hummingbird feeders. These feeders are distinct from the conventional feeder in that, rather than the usual dry food consumed by most birds, the hummingbird feeds on simulated nectar. The nectar is formed from water sweetened with sugar or honey. The feeders are then typically located where a human observer can observe the feeding hummingbirds. However, use of a feeder by a plurality of hummingbirds is often discouraged by a dominant male which treats the feeder as his territory. The dominant male will watch over the feeder and attack or otherwise discourage other hummingbirds, which the dominant male may regard as interlopers. The result is that the feeder may be used by only one bird, thereby greatly diminishing the pleasure of the human observer, who most likely will want to see a number of hummingbirds.

Accordingly, there is a demand for an improved hummingbird feeder device that allows multiple hummingbirds to use the device at the same time. More particularly, there is a demand for a hummingbird feeder device that offers a fully portable unit that can be disposed of when empty.

Therefore, there exists a long felt need in the art for a hummingbird feeder device that provides users with a self-contained box with an internal pouch filled with a food mixture for hummingbirds. There is also a long felt need in the art for a hummingbird feeder device that offers a fully portable unit. Further, there is a long felt need in the art for a hummingbird feeder device that affords bird lovers a pre-filled eco-friendly option that can be hung anywhere or rested on a flat surface. Moreover, there is a long felt need in the art for a device that attracts and feeds hummingbirds while providing enjoyment to bird watchers. Further, there is a long felt need in the art for a hummingbird feeder device that eliminates the need to buy food mix and a separate feeder. Finally, there is a long felt need in the art for a hummingbird feeder device that can be disposed of when empty.

The subject matter disclosed and claimed herein, in one embodiment thereof, comprises a hummingbird feeder device. The device is an easier and more convenient way to feed and attract hummingbirds. The hummingbird feeder device comprises a housing component that is configured in a triangular-shaped elongated design with an open interior cavity. The housing component measures approximately 12-14 inches in length. An internal bladder or pouch filled with nectar/hummingbird food is disclosed within the open interior cavity. The housing component comprises multiple removable sections on the triangular design, which are removed to access the pouch. Once removed, feeding plugs are pulled out from the pouch on all sides of the triangular design. The feeding plugs typically resemble a live flower with a hole in the center for access to the nectar from the pouch. When the feeding plugs are pulled out, nectar from the pouch is exposed, which will in turn attract and feed nearby hummingbirds. The device is disposed of when empty. Further, the device can be hung or rested on a flat surface.

In this manner, the hummingbird feeder device of the present invention accomplishes all of the forgoing objectives and provides users with a device that affords bird lovers a pre-filled eco-friendly option that can be hung anywhere or rested on a flat surface for use. The device is disposable. The device eliminates the need to buy food mix and a separate feeder.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hummingbird feeder device. The device is an easier and more convenient way to feed and attract hummingbirds. The hummingbird feeder device comprises a housing component with an open interior cavity. An internal bladder or pouch filled with nectar/hummingbird food is disclosed within the open interior cavity. The internal pouch includes feeding plugs which allow hummingbirds to access the nectar from the pouch. When the feeding plugs are pulled out, nectar from the pouch is exposed, which will in turn attract and feed nearby hummingbirds.

In one embodiment, the hummingbird feeder device of the present invention provides a self-contained feeder with an internal pouch that is pre-filled with nectar for hummingbirds. Specifically, the hummingbird feeder device comprises a housing component configured in a triangular-shaped elongated design with an open interior cavity. The exterior surface of the housing component comprises three exterior sides which are connected in a triangular configuration, with a top side and a bottom side. Typically, the housing component measures approximately 12-14 inches in length but can be available in different sizes and shapes as is known in the art.

In one embodiment, an internal bladder or pouch is pre-filled with nectar/hummingbird food and positioned within the open interior cavity. The top and bottom sides of the housing component secure the internal pouch within the housing component for use. The internal pouch is sized and shaped to fit within the interior cavity of the housing component. Typically, the internal pouch is manufactured of a flexible material. The internal pouch is pre-filled with simulated nectar or hummingbird food. Specifically, the internal pouch is filled with water sweetened with sugar or honey and then sealed. The internal pouch is then placed within the open interior cavity of the housing component and the top and bottom sides of the housing component are secured. Further, the internal pouch of the presently preferred embodiment is intended to hold a pre-filled, limited quantity of nectar or liquid food solution. This limited holding capacity of the internal pouch reduces the probability of spoilage and mold-formation that is common with large capacity conventional hummingbird feeders.

In one embodiment, the housing component comprises multiple removable sections on the triangular, cylinder, square, octagon, or any shape design, which are removed to access the internal pouch. Typically, each exterior side comprises a rounded removable section. The removable sections can be any suitable shape and size as is known in the art. The removable sections are typically perforated, such that they can be punched out and removed easily by a user. The removable sections are positioned towards the bottom side of the housing component but can be positioned in any suitable position on the housing component. Further, the removable sections can be in different positions on the housing component and do not need to be in the same position. The removable sections allow access to the interior cavity and also the internal pouch.

In one embodiment, once the removable sections are removed, feeding plugs are pulled out from the internal pouch on all sides of the triangular design. Specifically, the hummingbird feeder device includes a pre-filled nectar pouch positioned within the housing component. The pre-filled nectar pouch comprises a plurality of feeding plugs through which hummingbirds access nectar held in the internal pouch. Further, the internal pouch includes a lower end with at least one opening with a feeding plug, wherein the internal pouch is in liquid flow communication with the feeding plug. Nectar held in the internal pouch flows into the feeding plugs through the at least one opening and is accessed by hummingbirds through the feeding plugs in the internal pouch in the manner known by persons of skill in the art.

In one embodiment, the feeding plugs may simply be small openings in the pouch or exterior surface of the pouch through which the hummingbird inserts its beak. The feeding plugs align with the removable sections, such that when the removable sections are removed, the feeding plugs can be accessed. When the feeding plugs are pulled out, nectar from the internal pouch is exposed, which will in turn attract and feed nearby hummingbirds.

In one embodiment, the openings in the internal pouch are larger and are made to receive artificial flower assemblies. Each flower assembly typically includes a flower body made to resemble the petals of a real flower and a center hole through which the hummingbird accesses the nectar from the internal pouch. Further, the flower assembly includes an artificial flower body and a mounting member. The flower body comprises multiple petal rings nested together with a central opening. Having multiple petal rings enhances the realistic appearance of the flower body. However, the mounting member according to the present invention may be used with flower bodies having only a single petal ring, as well as on feeders that do not include any petal rings or flower bodies. In one embodiment, the flower assemblies and their parts may be red, blue, green, purple, yellow, orange, black, white, brown, pink or any other combination of colors as is known in the art.

In one embodiment, the feeding plugs are of sufficient length to prevent access to food stored within the internal pouch by bees, insects and/or short-billed birds while still allowing a hummingbird to feed. Therefore, according to the preferred embodiment of the present invention, the feeding plugs should be long enough to prevent access to the liquid food solution by unwanted animals, and of sufficient length that a feeding hummingbird can reach the nectar.

In one embodiment, the feeding plugs give the appearance of a flower attached by a tube to the internal pouch. The flower could be further supported by a perch that will allow the hummingbird to land and feed from the simulated pistil which communicates with the internal pouch. Thus, the plurality of feeding plugs each in liquid communication with the internal pouch, afford a perching position for a hummingbird at each one of the feeding plugs. The perches arc configured to receive and accommodate a hummingbird therein.

In one embodiment, once the internal pouch is emptied by the feeding hummingbirds, the device is disposed of. Accordingly, when the device is empty, a user can dispose of it and buy another. In another embodiment, the device can be refillable. Specifically, the internal pouch can be thrown away and a new pouch can be positioned within the interior cavity of the housing component and secured for use.

In one embodiment, the device can be hung for use. Specifically, the top side of the housing component can comprise a rope, lanyard, tie, or hook which allows the device to be hung in a tree, on a stand, on a house, or other suitable place as is known in the art. If a hook is provided, the hook is configured to enable the hummingbird feeder device to be suspended from an environmental object, such as a link of a chain, a rope, etc. In another embodiment, the device can be rested on a flat surface, such as a table, counter, shelf, etc., for use. Specifically, the device is rested on its flat, bottom side.

In one embodiment, the hummingbird feeder device is preferably constructed of durable materials having sufficient ultraviolet (“UV”) resistant properties. For example, the housing component is constructed of cardboard or thermoplastic material, such as polypropylene, acrylonitrile-butadiene-styrene (ABS), acrylic, polycarbonate, polyethylene, polyethylene terephthalate, polyvinyl chloride, polystyrene, etc., and is preferably translucent to facilitate visual inspection of the internal pouch and any liquid contained therein to determine if the pouch is empty and needs to be discarded. Generally, the hummingbird feeder device is also manufactured from a material that is water resistant or waterproof, or the housing component comprises a coating that is water resistant or waterproof. Furthermore, instead of being translucent, the device can be molded in various colors and patterns to match existing decor, based upon a user's preference.

In yet another embodiment, the hummingbird feeder device comprises a plurality of indicia.

In yet another embodiment, a method of attracting and feeding hummingbirds is disclosed. The method includes the steps of providing a hummingbird feeder device comprising a housing component with an internal pouch of nectar. The method also comprises removing the removable sections to expose the feeding plugs. Further, the method comprises pulling out the feeding plugs to expose the nectar from the internal pouch to attract hummingbirds. The method also comprises hanging the device or resting the device on a flat surface for use. Finally, the method comprises disposing of the device when empty.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the hummingbird feeder device of the present invention showing the device hanging from a tree in accordance with the disclosed architecture;

FIGS. 2A-B illustrate a perspective view of one embodiment of the hummingbird feeder device of the present invention showing the internal pouch filled with nectar in accordance with the disclosed architecture;

FIGS. 3A-B illustrate a perspective view of one embodiment of the hummingbird feeder device of the present invention showing the removable sections and flower feeding plugs in accordance with the disclosed architecture;

FIGS. 4A-B illustrate a perspective view of one embodiment of the hummingbird feeder device of the present invention showing all three feeding plugs pulled out in accordance with the disclosed architecture;

FIG. 5 illustrates a perspective view of one embodiment of the hummingbird feeder device of the present invention showing the device in use in accordance with the disclosed architecture; and

FIG. 6 illustrates a flowchart showing the method of attracting and feeding hummingbirds in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a hummingbird feeder device that provides users with a self-contained box with an internal pouch filled with a food mixture for hummingbirds. There is also a long felt need in the art for a hummingbird feeder device that offers a fully portable unit. Further, there is a long felt need in the art for a hummingbird feeder device that affords bird lovers a pre-filled eco-friendly option that can be hung anywhere or rested on a flat surface. Moreover, there is a long felt need in the art for a device that attracts and feeds hummingbirds while providing enjoyment to bird watchers. Further, there is a long felt need in the art for a hummingbird feeder device that eliminates the need to buy food mix and a separate feeder. Finally, there is a long felt need in the art for a hummingbird feeder device that can be disposed of when empty.

The present invention, in one exemplary embodiment, is a novel hummingbird feeder device. The device is an easier and more convenient way to feed and attract hummingbirds. The hummingbird feeder device comprises a housing component that is configured in a triangular-shaped elongated design with an open interior cavity. An internal bladder or pouch filled with nectar/hummingbird food is disclosed within the open interior cavity. The housing component comprises multiple removable sections on the triangular design, which are removed to access the pouch. Once removed, feeding plugs are pulled out from the pouch on all sides of the triangular design. The feeding plugs typically resemble a live flower with a hole in the center for access to the nectar from the pouch. When the feeding plugs are pulled out, nectar from the pouch is exposed, which will in turn attract and feed nearby hummingbirds. The present invention also includes a novel method of attracting and feeding hummingbirds. The method includes the steps of providing a hummingbird feeder device comprising a housing component with an internal pouch of nectar. The method also comprises removing the removable sections to expose the feeding plugs. Further, the method comprises pulling out the feeding plugs to expose the nectar from the internal pouch to attract hummingbirds. The method also comprises hanging the device or resting the device on a flat surface for use. Finally, the method comprises disposing of the device when empty.

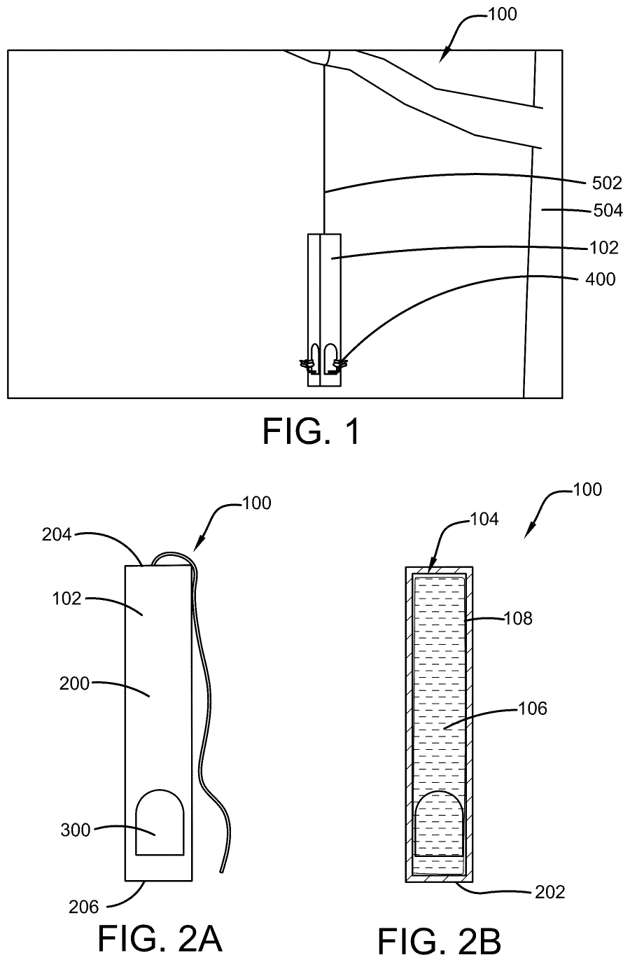

Referring initially to the drawings, FIG. 1 illustrates a perspective view of one embodiment of the hummingbird feeder device 100 of the present invention. In the present embodiment, the hummingbird feeder device 100 is an improved hummingbird feeder device 100 that provides bird lovers with a pre-filled, eco-friendly option that can be hung anywhere. Specifically, the hummingbird feeder device 100 comprises a housing component 102 with an open interior cavity 104. An internal bladder or pouch 106 filled with nectar/hummingbird food 108 is disclosed within the open interior cavity 104. The internal pouch 106 includes feeding plugs 110 which allow hummingbirds 112 to access the nectar 108 from the pouch 106. When the feeding plugs 110 are pulled out, nectar 108 from the pouch 106 is exposed, which will in turn attract and feed nearby hummingbirds 112.

As shown in FIGS. 2A-B, the hummingbird feeder device 100 of the present invention provides a self-contained feeder with an internal pouch 106 that is pre-filled with nectar 108 for hummingbirds 112. Specifically, the hummingbird feeder device 100 comprises a housing component 102 configured in a triangular-shaped elongated design with an open interior cavity 104. The exterior surface 200 of the housing component 102 comprises three exterior sides 202 which are connected in a triangular configuration, with a top side 204 and a bottom side 206. Typically, the housing component 102 measures approximately 12-14 inches in length but can be available in different sizes and shapes as is known in the art.

Further, an internal bladder or pouch 106 is pre-filled with nectar/hummingbird food 108 and positioned within the open interior cavity 104. The top 204 and bottom 206 sides of the housing component 102 secure the internal pouch 106 within the housing component 102 for use. The internal pouch 106 is sized and shaped to fit within the interior cavity 104 of the housing component 102. Typically, the internal pouch 106 is manufactured of a flexible material. The internal pouch 106 is pre-filled with simulated nectar or hummingbird food 108. Specifically, the internal pouch 106 is filled with water sweetened with sugar or honey and then sealed. The internal pouch 106 is then placed within the open interior cavity 104 of the housing component 102 and the top 204 and bottom 206 sides of the housing component 102 are secured. Further, the internal pouch 106 of the presently preferred embodiment is intended to hold a pre-filled, limited quantity of nectar or liquid food solution 108. This limited holding capacity of the internal pouch 106 reduces the probability of spoilage and mold-formation that is common with large capacity conventional hummingbird feeders.

Additionally, once the internal pouch 106 is emptied by the feeding hummingbirds 112, the device 100 is disposed of. Accordingly, when the device 100 is empty, a user can dispose of it and buy another. In another embodiment, the device 100 can be refillable. Specifically, the internal pouch 106 can be thrown away and a new pouch 106 can be positioned within the interior cavity 104 of the housing component 102 and secured for use.

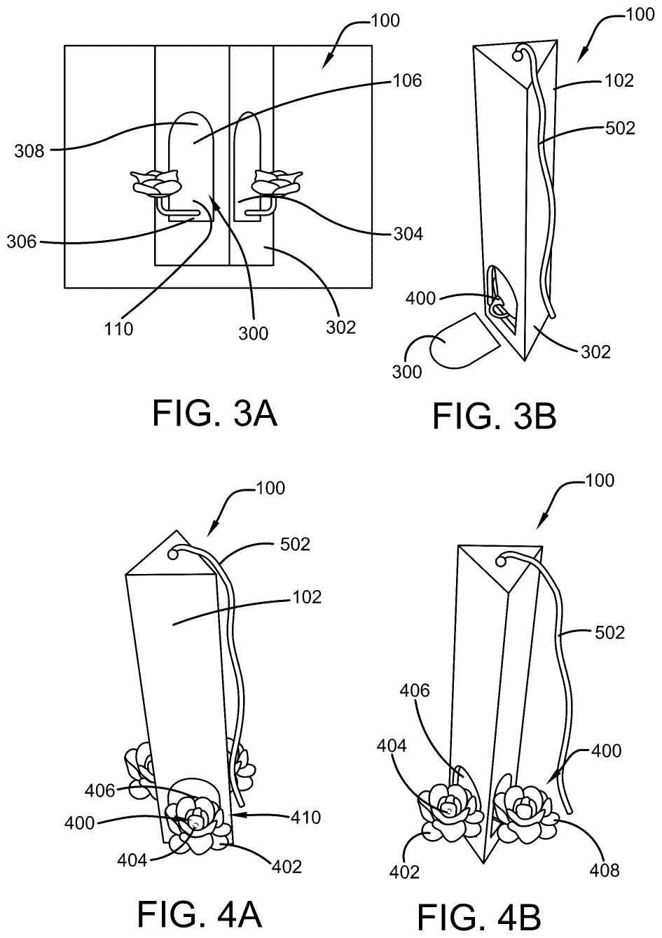

As shown in FIGS. 3A-B, the housing component 102 comprises multiple removable sections 300 on the triangular design, which are removed to access the internal pouch 106. Typically, each exterior side 202 comprises a rounded removable section 300. The removable sections 300 can be any suitable shape and size as is known in the art. The removable sections 300 are typically perforated, such that they can be punched out and removed easily by a user. The removable sections 300 are positioned towards the bottom side 302 of the housing component 102 but can be positioned in any suitable position on the housing component 102. Further, the removable sections 300 can be in different positions on the housing component 102 and do not need to be in the same position. The removable sections 300 allow access to the interior cavity 104 and also the internal pouch 106.

Further, once the removable sections 300 are removed, feeding plugs 110 are pulled out from the internal pouch 106 on all sides 202 of the triangular design. Specifically, the hummingbird feeder device 100 includes a pre-filled nectar pouch 106 positioned within the housing component 102. The pre-filled nectar pouch 106 comprises a plurality of feeding plugs 110 through which hummingbirds 112 access nectar 108 held in the internal pouch 106. Further, the internal pouch 106 includes a lower end 304 with at least one opening 306 with a feeding plug 110, wherein the internal pouch 106 is in liquid flow communication with the feeding plug 110. Nectar 108 held in the internal pouch 106 flows into the feeding plugs 110 through the at least one opening 306 and is accessed by hummingbirds 112 through the feeding plugs 110 in the internal pouch 106 in the manner known by persons of skill in the art.

In one embodiment, the feeding plugs 110 may simply be small openings 306 in the pouch 106 or exterior surface 308 of the pouch 106 through which the hummingbird 112 inserts its beak. The feeding plugs 110 align with the removable sections 300, such that when the removable sections 300 are removed, the feeding plugs 110 can be accessed. When the feeding plugs 110 are pulled out, nectar 108 from the internal pouch 106 is exposed, which will in turn attract and feed nearby hummingbirds 112.

As shown in FIGS. 4A-B, the openings 306 in the internal pouch 106 are larger and are made to receive artificial flower assemblies 400. Each flower assembly 400 typically includes a flower body 402 made to resemble the petals of a real flower and a center hole 404 through which the hummingbird 112 accesses the nectar 108 from the internal pouch 106. Further, the flower assembly 400 includes an artificial flower body 402 and a mounting member 406. The flower body 402 comprises multiple petal rings 408 nested together with a central opening 404. Having multiple petal rings 408 enhances the realistic appearance of the flower body 402. However, the mounting member 406 according to the present invention may be used with flower bodies 402 having only a single petal ring 408, as well as on feeders that do not include any petal rings 408 or flower bodies 402. In one embodiment, the flower assemblies 400 and their parts may be red, blue, green, purple, yellow, orange, black, white, brown, pink or any other combination of colors as is known in the art.

Further, the feeding plugs 110 are of sufficient length to prevent access to food stored within the internal pouch 106 by bees, insects and/or short-billed birds while still allowing a hummingbird 112 to feed. Therefore, according to the preferred embodiment of the present invention, the feeding plugs 110 should be long enough to prevent access to the liquid food solution by unwanted animals, and of sufficient length that a feeding hummingbird 112 can reach the nectar 108.

In one embodiment, the feeding plugs 110 give the appearance of a flower attached by a tube 406 to the internal pouch 106. The flower assembly 400 could be further supported by a perch 410 that will allow the hummingbird 112 to land and feed from the simulated pistil 400 which communicates with the internal pouch 106. Thus, the plurality of feeding plugs 110 each in liquid communication with the internal pouch 106, afford a perching position 410 for a hummingbird 112 at each one of the feeding plugs 110. The perches 410 are configured to receive and accommodate a hummingbird 112 therein.

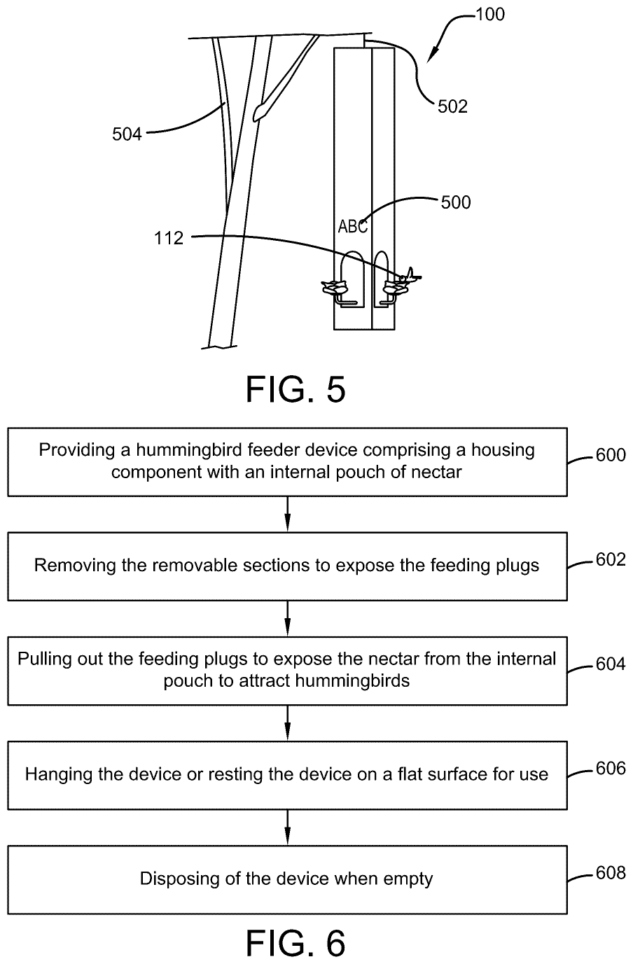

As shown in FIG. 5, the device 100 can be hung for use. Specifically, the top side 204 of the housing component 102 can comprise a rope 502, lanyard, tie, or hook which allows the device 100 to be hung in a tree 504, on a stand, on a house, or other suitable place as is known in the art. If a hook is provided, the hook is configured to enable the hummingbird feeder device 100 to be suspended from an environmental object, such as a link of a chain, a rope, etc. In another embodiment, the device 100 can be rested on a flat surface, such as a table, counter, shelf, etc., for use. Specifically, the device 100 is rested on its flat, bottom side.

In one embodiment, the hummingbird feeder device 100 is preferably constructed of durable materials having sufficient ultraviolet (“UV”) resistant properties. For example, the housing component 102 is constructed of cardboard or thermoplastic material, such as polypropylene, acrylonitrile-butadiene-styrene (ABS), acrylic, polycarbonate, polyethylene, polyethylene terephthalate, polyvinyl chloride, polystyrene, etc., and is preferably translucent to facilitate visual inspection of the internal pouch 106 and any liquid contained therein to determine if the pouch 106 is empty and needs to be discarded. Generally, the hummingbird feeder device 100 is also manufactured from a material that is water resistant or waterproof, or the housing component 102 comprises a coating that is water resistant or waterproof. Furthermore, instead of being translucent, the device 100 can be molded in various colors and patterns to match existing decor, based upon a user's preference.

In yet another embodiment, the hummingbird feeder device 100 comprises a plurality of indicia 500. The housing component 102 of the device 100 may include advertising, a trademark, or other letters, designs, or characters, printed, painted, stamped, or integrated into the stool component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be hummingbird, feeder, or brand related.

FIG. 6 illustrates a flowchart of the method of attracting and feeding hummingbirds. The method includes the steps of at 600, providing a hummingbird feeder device comprising a housing component with an internal pouch of nectar. The method also comprises at 602, removing the removable sections to expose the feeding plugs. Further, the method comprises at 604, pulling out the feeding plugs to expose the nectar from the internal pouch to attract hummingbirds. The method also comprises at 606, hanging the device or resting the device on a flat surface for use. Finally, the method comprises at 608, disposing of the device when empty.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “hummingbird feeder device”, “hummingbird device”, “feeder device”, and “device” are interchangeable and refer to the stool with hummingbird feeder device 100 of the present invention.

Notwithstanding the forgoing, the hummingbird feeder device 100 of the present invention can be of any suitable size and configuration as is known in the art without affecting the overall concept of the invention, provided that it accomplishes the above stated objectives. One of ordinary skill in the art will appreciate that the hummingbird feeder device 100 as shown in FIGS. 1-6 is for illustrative purposes only, and that many other sizes and shapes of the hummingbird feeder device 100 are well within the scope of the present disclosure. Although the dimensions of the hummingbird feeder device 100 are important design parameters for user convenience, the hummingbird feeder device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hummingbird feeder device that provides a user with a pre-filled feeder that can be hung anywhere, the hummingbird feeder device comprising:
a housing component; and
an internal pouch;
wherein the housing component comprises an open interior cavity;
wherein the internal pouch is pre-filled with nectar;
wherein the internal pouch is positioned within the housing component; and
further wherein the internal pouch comprises at least one feeding plug, which is pulled out exposing the nectar and attracting hummingbirds.

2. The hummingbird feeder device of claim 1, wherein the housing component is configured in a triangular-shaped elongated design with the open interior cavity.

3. The hummingbird feeder device of claim 2, wherein an exterior surface of the housing component comprises three exterior sides which are connected in a triangular configuration, with a top side and a bottom side.

4. The hummingbird feeder device of claim 3, wherein the housing component measures approximately 12-14 inches in length.

5. The hummingbird feeder device of claim 4, wherein once the internal pouch is emptied by feeding hummingbirds, the hummingbird feeder device is disposed of.

6. The hummingbird feeder device of claim 4, wherein the housing component is refillable once the internal pouch is emptied.

7. The hummingbird feeder device of claim 4, wherein the housing component comprises a removable section on each exterior side of the housing component which allows access to the open interior cavity.

8. The hummingbird feeder device of claim 7, wherein the removable section is perforated, punched out and removed by a user.

9. The hummingbird feeder device of claim 8, wherein the removable sections are positioned towards a bottom side of the housing component.

10. The hummingbird feeder device of claim 9, wherein once the removable sections are removed, the at least one feeding plugs are pulled out from the internal pouch to be accessed by the hummingbirds.

11. The hummingbird feeder device of claim 10, wherein the at least one feeding plugs are small openings in the internal pouch through which the hummingbird inserts a beak.

12. The hummingbird feeder device of claim 10, wherein the at least one feeding plugs are flower assemblies.

13. A hummingbird feeder device that provides a user with a pre-filled feeder that can be hung anywhere, the hummingbird feeder device comprising:
a housing component configured in a triangular-shaped elongated design with the open interior cavity; and
an internal pouch pre-filled with nectar;
wherein an exterior surface of the housing component comprises three exterior sides which are connected in a triangular configuration, with a top side and a bottom side;
wherein the internal pouch is positioned within the housing component;
wherein the housing component comprises a removable section on each exterior side of the housing component which allows access to the open interior cavity;
wherein the internal pouch comprises at least one feeding plug;
wherein once the removable sections are removed, the at least one feeding plugs are pulled out from the internal pouch to be accessed by the hummingbirds; and
further wherein the at least one feeding plugs are flower assemblies.

14. The hummingbird feeder device of claim 13, wherein each flower assembly comprises a flower body with a center hole through which the hummingbird accesses the nectar from the internal pouch and a mounting member.

15. The hummingbird feeder device of claim 14, wherein the flower body comprises multiple petal rings nested together with the central hole.

16. The hummingbird feeder device of claim 13, wherein the flower assembly comprises a perch for the hummingbird.

17. The hummingbird feeder device of claim 13, wherein the top side of the housing component comprises a rope to hang the hummingbird feeder device for use.

18. The hummingbird feeder device of claim 13, wherein the hummingbird feeder device can be rested on a flat surface for use.

19. The hummingbird feeder device of claim 13 further comprising a plurality of indicia.

20. A method of attracting and feeding hummingbirds, the method comprising the following steps:
providing a hummingbird feeder device comprising a housing component with an internal pouch of nectar;
removing the removable sections to expose the feeding plugs;
pulling out the feeding plugs to expose the nectar from the internal pouch to attract hummingbirds;
hanging the device or resting the device on a flat surface for use; and
disposing of the device when empty.
